(19) United States
(12) Patent Application Publication
(10) Pub. No.: US 2024/0068853 A1
(43) Pub. Date: Feb. 29, 2024

(54) DEVICE FOR FLOW AND VOLUME MEASUREMENT AND CONSUMPTION DETECTION IN HYDRANTS, HOSE CONNECTIONS OR ANY TYPE OF OUTLET

(71) Applicant: Iñigo ALBAINA LÓPEZ DE ARMENTIA, Maruri (ES)

(72) Inventor: Iñigo ALBAINA LÓPEZ DE ARMENTIA, Maruri (ES)

(21) Appl. No.: 18/272,008

(22) PCT Filed: Jan. 17, 2022
(86) PCT No.: PCT/ES2022/070014

§ 371 Date: Jul. 12, 2023

(30) Foreign Application Priority Data
Jan. 19, 2021 (ES) U202100027

(51) Int. Cl. G01F 1/46

(52) U.S. Cl. CPC G01F 1/46

(57) ABSTRACT

Device for measuring the volume and volumetric flow in hydrants and hose connections, and in a generic way in any outlet or installation in which the space available for the installation of a flowmeter, meter or any currently existing system for the determination of the flow velocity, is not possible or is very expensive.

It consists of replacing the hose outlet fitting by a modified one wherein a system for creating a differential pressure to the fluid path is enabled inside. From the reading of this differential pressure, the flow that circulates through the outlet fitting will be deduced, and along with the time, the volume transferred. It will also serve as a consumption detector at the outlet.

### TECHNICAL FIELD

The present invention, as expressed in the title of this specification, relates to a device for measuring the volume and volumetric flow in hydrants and hose connections, and in a generic way in any outlet or installation in which the space available for the installation of a flowmeter, meter or any currently existing system for the determination of the flow velocity, is not possible or is very expensive.

The device consists of replacing the hose outlet fitting by a modified one wherein a system for creating a differential pressure to the fluid path is enabled inside. From the reading of this differential pressure, the flow that circulates through the outlet fitting will be deduced, and along with the time, the volume transferred. It will also serve as a consumption detector at the outlet.

### BACKGROUND OF THE INVENTION

Most hydrants and hose connections are used for municipal services; irrigation, cleaning, etc. and for firefighting. They are installations without any type of control in which consumption is usually authorised, although not registered, thus a source of uncertainty for supply network managers.

There are countless devices for measuring volumetric flow and volume, with all kinds of techniques and technologies. The use of differential pressure elements to determine the circulating flow through a closed duct is also standardised, as is the use of the so-called Prandtl tube to obtain the dynamic pressure of a fluid, or the Pitot tube and a static outlet.

They all exist as commercial elements with different models and variants, the main drawback of all of them being their size and generally high cost for the use that this particular application requires.

### EXPLANATION OF THE INVENTION

The invention consists in the use of the physical concept of creating a differential pressure, either with the use of a differential pressure element, or a Pitot or Prandtl tube, adapting it to an outlet fitting, so that the flow can be measured without having to modify the installation, or carry out any type of work that involves a high cost and that therefore makes its installation unfeasible as they are points with low and sporadic consumption. With the creation of the differential pressure in the connection fitting itself, it is only necessary to unscrew the original one and replace it with the modified fitting with the two outlets.

The differential pressure is created by means of a modified tube that faces the current, having the total pressure (Pitot) and a pressure outlet perpendicular to the duct that gives us the static pressure, such that a difference in pressures is created between the two outlets equivalent to the dynamic pressure. The differential pressure can also be created using a constriction (diaphragm or nozzle), such that the pressure differential is the difference in kinetic energies upstream and downstream of the constriction.

In the two above cases, from the difference in pressures, the fluid velocity is obtained, knowing the section, the flow; with the flow and time we obtain the volume of water that has circulated through the outlet.

The difference in pressures generated produces a circulation of water between the two in what we call the secondary circuit. The flow of this latter circuit is proportional to that of the primary circuit. A micro-flowmeter will measure the flow of the secondary circuit, since once this is known, that of the primary circuit will be known.

It will also be possible to measure the difference in pressures using a differential pressure transducer or any other element used for measuring pressures.

In turn, the device will serve as a consumption detector at the outlet.

### BRIEF DESCRIPTION OF THE DRAWINGS

FIG. 1.—Elevation view of the modified fitting with the static pressure outlet and the total pressure reading tube.

FIG. 2.—Section A-A′ showing the modified tube that captures the total pressure.

FIG. 3. Shows the plan view of the device, with the modified fitting, the static pressure outlet, total pressure outlet, connection tube and flowmeter.

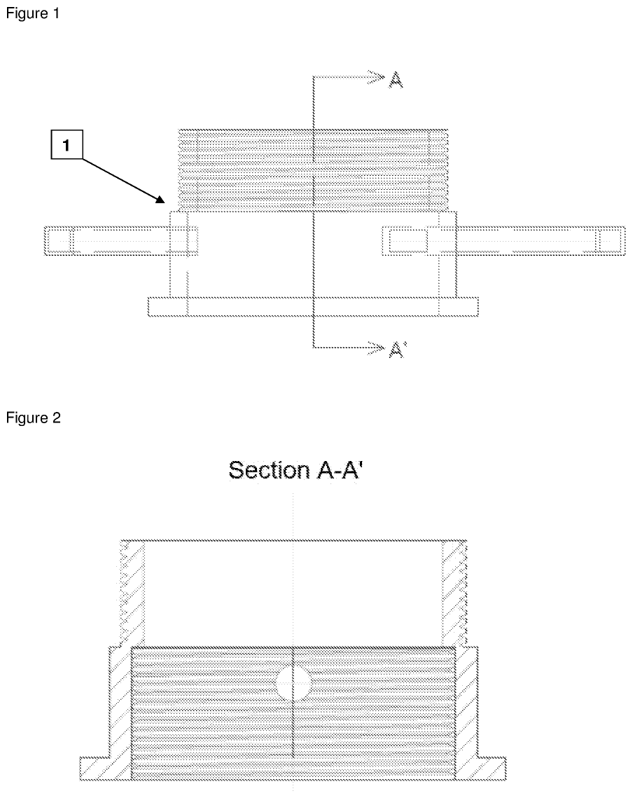

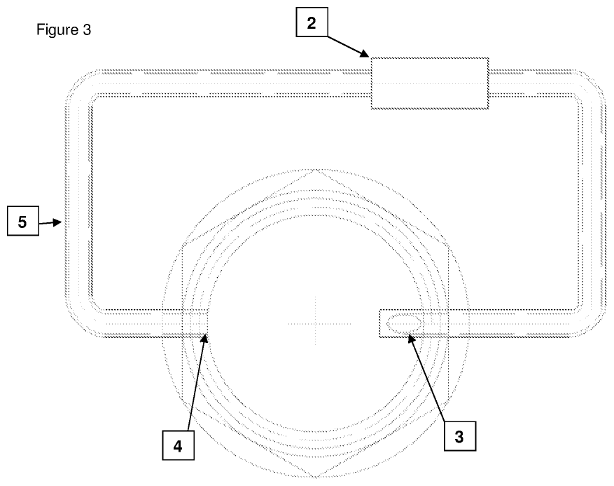

### PREFERRED EMBODIMENT OF THE INVENTION

In view of the aforementioned figures, it can be seen how the device is made up of a fitting assembly, made up in turn of a Barcelona-type fitting or the type that is installed in the hydrant or hose connection in which the device is to be installed, and a male-female Marsella-type extension fitting (1), both joined and perforated in their central part to make the outlets (3) and (4). The assembly can also be made in a single piece.

As a first option, a hollow tube (5), perforated (3) on one of its sides and the end, which is inserted into the fitting, being plugged, is inserted into one of the outlets.

As a second option, a differential pressure element such as a diaphragm or a nozzle is inserted into the fitting, and two pressure outlets are made, one upstream and the other downstream of the differential pressure element inserted.

In both cases, the necessary accessories are connected to communicate the outlets with tubes (5) that allow the circulation of the fluid, in the case of using a micro-flowmeter (2), and for the reading of the differential pressure in the case of using a pressure transducer or any element for reading it.

Both the elements for capturing the difference in pressures, as well as those for transmitting the data obtained, will be housed in sealed containers separated from the fitting and that can be housed in any available place in the manhole, this is to solve the problem of lack of space next to the outlet fitting.

1. A device for flow and volume measurement and consumption detection in hydrants, hose connections or any type of pipeline, comprising: made up of a fitting (1) having coupled to it a tube (3) which is plugged at the end and is inside the fitting (1) and has a hole (3), next to the plugged end, oriented so that the mentioned hole (3) is in the direction of the flow that circulates inside of the fitting (1); The other end of the tube (3) being connected to the inlet of the flowmeter (2); The fitting (1) has a second tube (5) coupled to it in which one of the ends (4) that is inside the fitting (1) is perpendicular to the current of fluid that circulates inside the fitting (1); The other end of the second tube (5) being connected to the outlet of the flowmeter (2).

2. The device according to claim 1, characterised in that the difference in pressures generated between the hole (3) and the end of the second tube (5) that is inside the fitting (1) is the dynamic pressure of the fluid inside the fitting (1), which is proportional to the square root of the velocity of the fluid, which multiplied by the section perpendicular to the current of fluid inside the fitting (1), gives us the primary flow that circulates inside the fitting (1) and therefore through the pipe to which the fitting (1) has been connected; The flow circulation generated between the hole (3) (total pressure) and the end of the second tube (5) that is inside the fitting (1) (static pressure) and which is measured by the flowmeter (2), therefore depends both on the dynamic pressure and on the load loss of the circuit formed by the tubes (3) and (5) and the flowmeter (2); The primary circulating flow through the pipe to which the fitting (1) is coupled, is therefore obtained from the reading of the secondary flow measured by the flowmeter (2).

3. (canceled)
